(19) United States
(12) Patent Application Publication
(10) Pub. No.: US 2010/0098803 A1
(43) Pub. Date: Apr. 22, 2010

(54) Processing Method of Sulfur Using Maggots

(76) Inventors: Sang Kyoo Lee, Gyeonggi-do (KR); Hae Bung Lee, Gangwondo (KR); Seng Sub Bang, Chungcheongham-do (KR)

Correspondence Address: Robert D. Atkins, 605 W. Knox Road, Suite 104, Tempe, AZ, 85284, US

(21) Appl. No.: 12/528,313

(22) PCT Filed: Feb. 22, 2008
(86) PCT No.: PCT/KR08/01046

§ 371 Date: Aug. 21, 2009

(30) Foreign Application Priority Data
Feb. 23, 2007 (KR) 10-2007-0018508

(51) Int. Cl. A23K 1/00

(52) U.S. Cl. 426/18

(57) ABSTRACT

The present invention relates to a processing method of sulfur using maggots in which fly egg is used to obtain effectively the processed sulfur so that domestic animal can take directly and safely the processed sulfur. That is, sulfur is over added to maggots food or the place where maggots can grow up, and when maggots discharge exudates to dissolute fodder, the sulfur presented randomly in the fodder is contact with the maggots exudates to dissolute fat that is become toxicity so that processed sulfur is obtained effectively through maggots?endless vigorous activity.

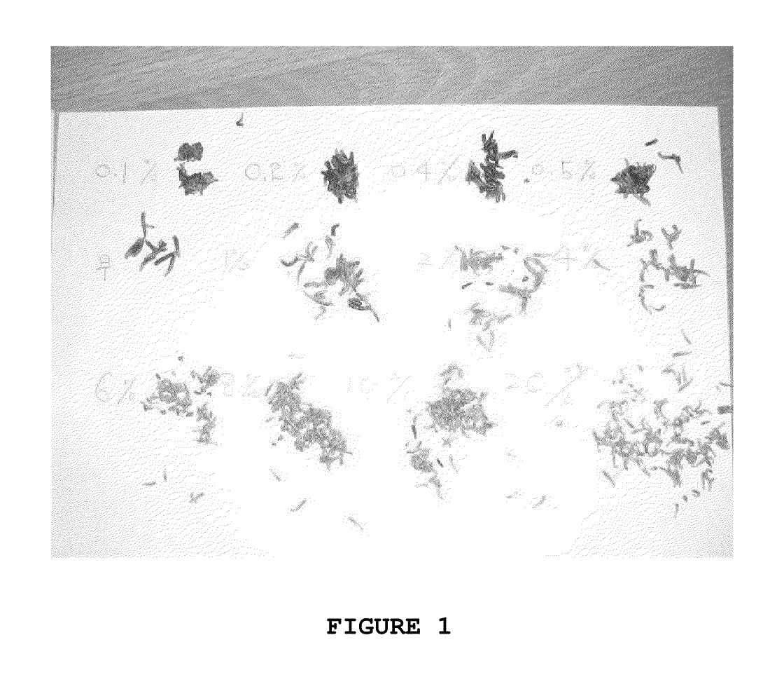

### TECHNICAL FIELD

The present invention mainly relates to a processing method of sulfur using maggots in order to process sulfur using maggots and feed directly and safely processed sulfur to domestic animal.

### BACKGROUND ART

The ingestion of sulfur, which has been known to improve liver function for digestion operation, reinforce skin tissue, harden bone, and increase immunity, is very important to human being and domestic animal.

### DISCLOSURE

### Technical Problem

Direct ingestion of sulfur is toxic to human body, and thus indirect indigestion is tried through duck, which is bred with excess indigestion of sulfur by fodder that is mixed with sulfur.

That is, even indigestion of sulfur is affirmative in much aspect, other domestic animal except of duck can not be taken sulfur due to its toxicity, and now thus human being can not take indirectly sulfur through domestic animal except for duck.

Generally, non-processed sulfur is mixed with food waste or domestic animal dung and then allows maggots to take it for becoming sulfur maggots, which is fed to domestic animal resulting in indirect indigestion of sulfur. However, in this way, there arises a problem in that domestic animal can not take sufficiently sulfur.

Meanwhile, since maggots do not have an organ to chew food and thus takes food of semi liquid such as soup, and for this purpose, maggots secrete strong digestion exudates to outside their body through blood lymph that is inside their body for dissolution of surrounding food into digestion exudates. In particular, maggots are well adapted to strong acid environment and thus can be grown up in anywhere corrosive food, proper temperature and moisture are given.

### Technical Solution

Accordingly, in the present invention, since when domestic animal (except of duck) is fed with sulfur, it is past away due to its toxicity, sulfur is processed by maggots exudates such that domestic animal except for duck can take safely the sulfur.

That is, according to present invention, sulfur is added to maggots food (hereinafter, referred to as “fodder”) and, when maggots discharge exudates to dissolute fodder, the sulfur presented randomly in the fodder is contact with the maggots exudates to dissolute fat that is become toxicity so that processed sulfur is obtained through maggots endless vigorous activity, which can be taken safely by all domestic animal.

In the present invention, the fodder to be selected as maggots food to obtain processed sulfur can be any substance that containing protein and carboxyl ate.

In the present invention, a sulfur processing method using maggots comprises a steps of: mixing sulfur of 5-20 wt % in weight comparison to total dried fodder excluding moisture, putting fly egg of 0.3 wt % in weight comparison to the total dried fodder, into the fodder mixed with sulfur, processing sulfur with digestion exudates excreted when the maggots hatched from the fly egg take the fodder, separating the sulfur from the fodder to obtain sulfur, and mixing the sulfur separated from the fodder with general fodder and feeding it so that much amount of processed sulfur is obtained and domestic animal including duck can take it.

### Advantageous Effects

According to the present invention, sulfur that can not be taken by domestic animal except for duck is processed so that omnivorous domestic animal including fowl can take the sulfur. When the domestic animals take the processed sulfur, immunity of the domestic animal increase to be grown up healthily without taking antibiotics, and liver function is improved to increase digestion operation and thus bad smell from dung of domestic animal can be reduced substantially.

Furthermore, the maggots obtained in a procedure of processing sulfur, that is, high protein maggots taking over amount of sulfur, is used as supplementary fodder together with sulfur, to be taken by domestic animal to improve fleshiness of the domestic animal and obtain high quality of product.

### Mode for Invention

The following embodiments are given for the purpose of illustration only and are not intended to limit the scope of this invention.

In the present invention, a predetermined amount of sulfur is added to maggots food (hereinafter, referred to as “fodder”) and then it allows maggots to take it so that when maggots discharge exudates to dissolute fodder, the sulfur mixed with the fodder is contact with the maggots exudates to dissolute fat that is become toxicity of sulfur so that processed sulfur is obtained, which can be taken safely by all domestic animal.

In the present invention, first, selection process of composition elements of maggots' fodder is described as follows.

In order to process effectively sulfur inside maggots fodder, i) exudates has to be secreted sufficiently, since the amount of exudates is proportion to maggots yield. ii) remaining amount of processed sulfur has to be much. iii) fodder and processed sulfur has to be separated easily. Accordingly, vegetable corn powder, soybean cake and wheat skin, instead of animality, can be used as the fodder to be selected as maggots food for processing sulfur. Corn powder is selected for ensuring carboxylate and fat, soybean cake is selected for ensuring protein, and wheat skin is selected for ensuring inorganic matter and ventilation. Here, three control groups each having different composition ratio of 3 kinds of fodders are prepared. When maggots are obtained from home fly eggs using the control groups, the result is shown in the following table 1.

Here, the fodder to be selected for forming three control groups is amount to 1 kg based on dried condition, and water is added to keep moisture in 65-75%, and soybean cake and corn powder are boiled for good dissolution.

In taking a consideration of an adult maggot being grown up 300-400 times weight of a fly egg, yield is estimated based 350 times as the average value of it.

TABLE 1

| | | | | | |
|---|---|---|---|---|---|
| | Corn 0.5 | | Corn 0.25 | | |
| A | Soybean cake 0.25 | B | Soybean cake 0.5 | C | Soybean cake 0.5 |
| Group | Wheat skin 0.25 | Group | Wheat skin 0.25 | Group | Wheat skin 0.5 |

| | | | |
|---|---|---|---|
| Home fly | 2.5 g | 2.5 g | 2.5 g |
| eggs put | | | |
| into | | | |
| Weight of | 417 g | 459 g | 509 g |
| adult | | | |
| maggot | | | |
| Yield | 46.7% | 51.4% | 58.2% |

fodder unit: kg

As shown in the above table, C group fodder, that is, when the fodder consists of soybean cake 0.5 kg and wheat skin 0.5 kg, the production amount of maggots is maximum value, that is, 509 g, and it means that protein (soybean cake) is supplied sufficiently to grow up effectively maggots, and further the grown up condition of maggots is effected by ensuring of ventilation and inorganic matter (wheat shin) rather than carboxylate and fat (corn).

That is, when growing up maggots, the higher the contents of soybean cake and wheat skin are, the higher the yield of maggots become. Accordingly, in the C group selecting soybean cake and wheat skin as fodder among 3 control groups, it is determined that the most amount of exudates is excreted from maggots.

Secondly, the process of determining a maximum addition rate of sulfur possible for processing sulfur is described.

Based on the table 1, a total of dried food 2 kg of soybean cake 1 kg, and wheat bran 1 kg, etc., was added to water 4.6 kt to keep moisture of 65-75%, and then set 8 control groups consisting of sulfur addition rate 0% (0 g), 0.1 wt % (2 g), 0.5 wt % (10 g), 1.0% (20 g), 5% (100 g), 10 wt % (200 g), 30 wt % (600 g), and 50 wt % (1000 g), based on dried fodder. After that, home fly eggs of 6 g (proper weight 5 g) were put over the aforementioned fodder, and observed a grown up state of maggots for 8 days and obtained the following result in table 2.

Here, when sulfur addition rate was equal to or more than 3-4 wt % based on dried fodder weight, due to corrosion inhibition property of sulfur itself, the digestion exudates from maggots could not dissolve normally fodder to slow maggots grown up. Accordingly, starter (yeast) 4 g was added to the control groups of sulfur addition rate 5 wt %, 10 wt %, 30 wt % and 50 wt %, respectively, and mixed evenly to help maggots to dissolve normally fodder. Meanwhile, the fodder height of the control group is limited to 5 cm and maggots took the fodder from the top to the bottom, and the remaining height of non-dissolved fodder was measured. Further, in taking a consideration of taking generally 6-7 days from hatching fly egg to becoming pupa, after 8 days, the remaining height of non-dissolved fodder was measured.

TABLE 2

| | S addition rate | | | | | | | |
|---|---|---|---|---|---|---|---|---|
| | 0% | 0.1% | 0.5% | 1.0% | 5.0% | 10% | 30% | 50% |
| After 1 day | ◯ | ◯ | ◯ | ◯ | ◯ | ◯ | ◯ | ◯ |
| After 2 days | ◯ | ◯ | ◯ | ◯ | ◯ | ◯ | ◯ | Δ |
| After 3 days | ◯ | ◯ | ◯ | ◯ | ◯ | ◯ | ◯ | Δ |
| After 4 days | ◯ | ◯ | ◯ | ◯ | ◯ | ◯ | Δ | □ |
| After 5 days | ◯ | ◯ | ◯ | ◯ | ◯ | ◯ | □ | X |
| After 6 days | ◯ | ◯ | ◯ | ◯ | ◯ | ◯ | □ | X |
| Height of | 0 cm | 0 cm | 0 cm | 0 cm | 0 cm | 0 cm | 3.5 cm | 4.6 |
| remaining | | | | | | | | cm |
| fodder after | | | | | | | | |
| 8 days | | | | | | | | |

◯: Good state,
Δ: Poor state,
□: Very poor state,
X: Dead State determining basis: Maggots activity and amount of each fodder dissolutions are measured, combined with the control group of addition rate 0%

As a result of analyzing the above table 2, it was shown that the maximum sulfur addition rate that was able to be processed was decided between sulfur addition rates of 10 wt % to 30 wt %, and thus the above experiment was repeated at 2 wt % interval, and thereby confirming that sulfur could be processed to a sulfur addition rate of 18 wt %.

That is, the maggots were input into 4 control groups of sulfur addition rates of 0 wt %, 5 wt %, 10 wt % and 15 wt %, comprising soybean cake 50 wt % and wheat skin 50 wt %, and were collected immediately before becoming pupa and indicated as FS0, FS5, FS10 and FS15, respectively, depending on sulfur content. The below table 3 shows that amino acid containing sulfur and total amount of 17 kinds of amino acid in each indication.

TABLE 3

| Amino acid | FS0 | FS5 | FS10 | FS15 |
|---|---|---|---|---|
| Cystine(mg/g) | 0.08 | 1.96 | 2.94 | 2.02 |
| Methionine(mg/g) | 12.94 | 11.92 | 11.51 | 11.31 |
| Total(mg/g) | 13.02 | 13.88 | 14.45 | 13.33 |
| Increasing rate | 0 | 6.6 | 10.9 | 2.3 |
| comparing to FS0(%) | | | | |
| Total amount of 17 | 444.08 | 495.33 | 521.83 | 537.28 |
| kinds amino acid(mg/g) | | | | |
| Increasing rate | 0 | 11.2 | 17.5 | 21.0 |
| comparing to FS0(%) | | | | |

As confirmed in the above table 3, in the control group FS0, FS5 and FS10 of comparison control groups, it is shown that total amount of amino acid containing sulfur gradually increase, however, in FS15 the amount increase a bit, and the total amount if 17 kinds amino acid increase proportionally.

In addition, it was confirmed that over-taking sulfur by maggots occurred in the course of processing sulfur resulted in increase of amino acid containing sulfur and total amount of 12 kinds amino acid. This results show apparently that the domestic animal taking sulfur maggots and processed sulfur is affected in any type in filed of amino acid containing sulfur and total amino acid.

The total amount of this amino acid is confirmed in the below material analyzed and issued by bio-food material development and industrialization center in CHUN BUK UNIVERSITY.

TABLE 4

| | | | | | | General | Fowl | Fowl | Fowl |
|---|---|---|---|---|---|---|---|---|---|
| Amino acid | PS 11 | MS 1 | MS 2 | MS 3 | MS 4 | fowl | MS 15 | MS 5 | MS 0 |
| Asparic acid | 41.63 | 44.48 | 43.64 | 44.80 | 46.18 | 28.48 | 23.31 | 32.66 | 23.55 |
| Threonine | 19.91 | 22.81 | 24.29 | 23.70 | 23.88 | 12.80 | 10.30 | 16.65 | 9.77 |
| Serine | 19.02 | 21.44 | 24.23 | 23.60 | 23.67 | 14.93 | 12.71 | 24.75 | 13.75 |
| Glutamic acid | 63.24 | 68.14 | 72.33 | 70.70 | 73.78 | 53.52 | 42.50 | 68.60 | 43.05 |
| Proline | 19.72 | 22.09 | 23.48 | 22.58 | 23.47 | 37.42 | 21.66 | 50.92 | 29.87 |
| Glycine | 19.71 | 21.25 | 23.83 | 23.66 | 23.38 | 38.84 | 30.69 | 47.23 | 37.53 |
| Alanine | 20.96 | 28.93 | 28.38 | 27.45 | 29.62 | 30.48 | 20.22 | 35.28 | 24.66 |
| *Cystine | 0.16 | 0.08 | 1.96 | 2.94 | 2.02 | 0.51 | 0.69 | 1.08 | ND |
| Valine | 24.25 | 26.59 | 26.43 | 26.46 | 26.66 | 14.64 | 11.17 | 18.16 | 11.54 |
| *Methionine | 7.61 | 12.94 | 11.92 | 11.51 | 11.31 | 5.72 | 5.16 | 7.78 | 4.31 |
| Isoleucine | 17.81 | 20.54 | 20.98 | 20.21 | 20.39 | 11.25 | 9.83 | 15.15 | 9.13 |
| Leucine | 29.36 | 34.10 | 35.95 | 35.69 | 35.90 | 22.02 | 18.17 | 28.58 | 16.70 |
| Tyrosine | 0.86 | 1.72 | 6.76 | 44.22 | 47.94 | 8.45 | 7.53 | 12.12 | 0.32 |
| Phenylalanine | 20.59 | 32.59 | 43.27 | 42.08 | 45.87 | 12.75 | 9.94 | 16.94 | 8.25 |
| Histidine | 39.14 | 29.97 | 47.27 | 42.21 | 43.34 | 13.82 | 10.37 | 14.38 | 2.24 |
| Lysine | 28.14 | 29.09 | 30.61 | 29.81 | 30.30 | 21.81 | 18.18 | 25.37 | 16.39 |
| Ammonia | 3.65 | 3.13 | 3.11 | 3.08 | 3.13 | 2.44 | 2.18 | 2.72 | 2.83 |
| Arginine | 27.32 | 27.32 | 30.00 | 30.21 | 29.57 | 31.60 | 21.80 | 43.99 | 24.90 |
| Total amount of | | 13.02 | 13.88 | 14.45 | 13.33 | | | | |
| amino acid | | | | | | | | | |
| Containing sulfur | | | | | | | | | |
| Total amount of | | 444.08 | 495.53 | 521.83 | 537.28 | | | | |
| all kinds amino | | | | | | | | | |
| acid | | | | | | | | | |

unit: mg/g
*Cystine and Methionine are amino acid containing sulfur

The below picture shows the maggots that were grown up for 6 days from hatching a fly egg, using fish 50 wt % and wheat skin 50 wt % keeping 70% moisture as maggots fodder. In the picture, it is shown that depending on the sulfur addition rate, the higher the sulfur addition rate is, the smaller the body of maggots become, and the body color changed brightly.

In case of maggots being grown up using vegetable fodder for processing sulfur, when some animal fodder is used, instead of vegetable fodder, the sulfur addition rate capable of being processed can be increased due to high-protein, however, the amount of processed remaining sulfur is much smaller than vegetable fodder.

The data in Table 5 are this experimental result, which show the remaining amount of processed sulfur of the fodder from which maggots were collected and which was dried.

TABLE 5
Comparison of the amount of the processed remaining sulfur

| | fodder | S | S | S | |
|---|---|---|---|---|---|
| Sorts of | composition | addition | addition | remaining | |
| fodder | (1 kg) | amount | rate | amount | Note |
| FS10 fodder | Soybean | 100 g | 10% | 29.5 wt % | It is |
| | cake | | | | necessary |
| | 50 wt % | | | | to consider |
| | Wheat skin | | | | total weight |
| | 50 wt % | | | | after drying |
| FS10 fodder | Fish | 100 g | 10% | 6.71 wt % | fodder |
| (comparison) | 50 wt % | | | | |
| | Wheat skin | | | | |
| | 50 wt % | | | | |

In taking a consideration of total weight of fodder after drying, as for same weight sulfur (100 g), the proceed sulfur remaining value in the fodder (FS10), consisting of soybean cake and wheat skin, is 29.5 wt %, and it is 6.7 wt % in the fodder (FS10, comparison), comprising fish, which confirms that the processed sulfur remaining value is much small in case of comprising animal high-protein fodder.

Thirdly, a procedure of separating maggots and sulfur included in the sulfur fodder is as follows.

In order to separate the maggots from sulfur in maggots fodder, first, the maggots fodder is spread over a flat heat plate. In sequence, the heat plate is heated to 40-45° C. and lighted with a fluorescent lamp and then the maggots crawl out of the heat plate to be collected.

In addition, since sulfur has a specific gravity of 2.07 and the maggots fodder is corrupted to be lighter than water, the fodder comprising sulfur is wrapped with a fine network and soaked into water, and the network is vibrated. As a result, most sulfur contained in the network is shaked out of the network, which is piled up on the bottom to be separated easily from the fodder. The separated sulfur is wet and thus promptly drawn up for drying.

As other method for the separate, the maggots are removed from the fodder in which sulfur is remained, and then the remaining maggots fodder are dried and finely ground for processing with a centrifuge.

Fourthly, a procedure of whether the sulfur is processed or not is described as follows.

As a method of confirming the process of sulfur using maggots exudates, the exudates together with general mixing fodder was fed with a broiler of 1.0 kg or so of body weight.

In more detail of experiment, referring that the addition rate of sulfur capable of being processed in the general grain fodder was 18 wt %, the sulfur obtained above was to be mixed with general mixing fodder, wherein sulfur to be processed was added at rate of 05 wt %, 1.0 wt %, 1.5 wt %, 2.0 wt % and 2.5 wt %, and the broilers were classed as 5 groups each having 3, and then was fed with fodder that was mixed with the sulfur to be processed. After 7 days of growing up, the obtained result was shown as follows in table 6.

TABLE 6
The growing up state of fowl depending on the addition amount of the
processed sulfur

| | 1st | | 3rd | | | |
|---|---|---|---|---|---|---|
| | group | | group | | | |
| | (S | 2nd group | (S | 4th group | 5th group | |
| Class | 0.5%) | (S 1.0%) | 1.5%) | (S 2.0%) | (S 2.5%) | Note |
| 1st date | ◯ | ◯ | ◯ | ◯ | ◯ | Good |
| 2nd date | ◯ | ◯ | ◯ | ◯ | ◯ | Good |
| 3rd date | ◯ | ◯ | ◯ | ◯ | ◯ | Good |
| 4th date | ◯ | ◯ | ◯ | ◯ | ◯ | Good |
| 5th date | ◯ | ◯ | ◯ | ◯ | ◯ | Good |
| 6th date | ◯ | ◯ | ◯ | ◯ | ◯ | Good |
| 7th date | ◯ | ◯ | ◯ | ◯ | ◯ | Good |

◯: 3 maggots alive
Sulfur(S) addition rate = sulfur weight/total weight of dried broiler

As shown in table 6, total of 15 fowls were tested and they were all healthy, and no malignant effect was found with sulfur addition, which means that sulfur process of the present invention was performed satisfactorily.

### INDUSTRIAL APPLICABILITY

Though the present invention is described referring to the preferred embodiment according to each aspect of the present invention, it will be apparent to those skilled in the art that various modifications and variations can be made in the present invention. Thus, it is intended that the present invention covers the modifications and variations of this invention provided they come within the scope of the appended claims and their equivalents.

1. A method of processing sulfur using maggots, comprising
[a step of] putting the maggots into fodder mixed with sulfur; and
processing the sulfur with digestion exudates excreted during a feeding operation of the maggots.

2. A method of processing sulfur using maggots, comprising:
mixing sulfur of 5-20 wt % in weight comparison to total dried fodder excluding moisture;
putting fly egg of 0.3 wt % in weight comparison to the total dried fodder, into the fodder mixed with the sulfur;
processing the sulfur with digestion exudates excreted when the maggots hatched from the fly egg taken from the fodder; and
separating the sulfur from the fodder.

3. A method of processing sulfur using maggots according to claim 1, wherein a time of processing sulfur is controlled by the protein content of the maggots' fodder and the amount of maggots.

4. A method of obtaining a sulfur maggot and its pupa using a method of processing sulfur using maggots according to claim 1.

5. A method of processing sulfur using maggots according to claim 2, wherein the sulfur processed with digestion exudates from the maggots, mixed with the fodder, is separated from the fodder using specific gravity.

6. A method of processing sulfur using maggots according to claim 2, wherein the time of processing sulfur is controlled by the protein content of the maggots' fodder and the amount of maggots.

7. A method of obtaining a sulfur maggot and its pupa using a method of processing sulfur using maggots according to claim 2.
